(19) United States
(12) Patent Application Publication
(10) Pub. No.: US 2007/0007873 A1
(43) Pub. Date: Jan. 11, 2007

(54) Frame/mask assembly for cathode-ray tube

(75) Inventors: Pedro Cosma, Roma (IT); Carlo Tulli, Roma (IT); Paolo Ginesti, Gavignano (IT)

Correspondence Address: Joseph S Tripoli;Thomson Licensing Inc., Patent Operations, Post Office Box 5312, Princeton, NJ, 08543-5312, US

(73) Assignee: THOMSON LICENSING S.A., Boulogne (FR)

(21) Appl. No.: 10/564,675

(22) PCT Filed: Jul. 9, 2004
(86) PCT No.: PCT/FR04/50323

§ 371 Date: Aug. 9, 2006

(30) Foreign Application Priority Data
Jul. 18, 2003 (IT) MI2003 A 001473

(51) Int. Cl. H01J 29/80

(52) U.S. Cl. 313/407

(57) ABSTRACT

Cathode ray tube with colour selection mask comprising a frame designed to hold the mask at a distance from the screen, the said frame of a noticeably rectangular shape has a pair of short parallel sides of a noticeably L-shaped cross-section with a lateral flank extending in a direction parallel to the longitudinal axis connected to a flange noticeably perpendicular to the said longitudinal axis, the width of the flange of each short side is lower in the middle of the side than at its extremities such that the inner edge of the flange defines a curve whose concavity is oriented toward the longitudinal axis of the tube. This frame structure improves the thermal behaviour of the frame/mask assembly and reduces the weight of the materials for producing the frame while maintaining a sufficient mechanical rigidity.

The present invention relates to a colour cathode ray tube with a noticeably flat screen, and more specifically a colour selection frame/mask assembly equipping such a tube.

The invention finds its application in any type of tube comprising a colour selection mask and is more particularly adapted for tubes with a mask that is realised by stamping and is held in place within the tube by a rigid frame to which it is joined.

A conventional cathode ray tube comprises a glass envelope under vacuum. Within the envelope, the tube comprises a colour selection mask located at a precise distance from the glass front face of the tube, front face on which red, green and blue luminophore networks are laid to form a screen. An electron gun is arranged within the rear part of the tube according to the direction of the longitudinal axis of the tube, the said axis passing through the centre of the front face, the said gun generating three electronic beams in the direction of the said front face. An electromagnetic deflection device, generally located outside the tube and close to the electron gun has the function of deviating the electronic beams so as to sweep them over the surface of the panel on which the luminophore networks are arranged. Under the influence of three electronic beams each corresponding to a determined primary colour, the luminophore networks enable colour pictures to be reproduced on the screen, the mask enabling each determined beam to illuminate only the luminophore of the corresponding colour.

The colour selection mask must be arranged and maintained in a specific position within the tube during the operation of the tube. The mask support functions are realised owing to a generally very rigid rectangular metal frame on which the mask is conventionally welded.

The frame/mask assembly is mounted in the front face using suspension means welded on the frame and co-operating with lugs inserted into the glass constituting the front face of the tube.

The colour selection mask is realised from a metal sheet of a very low thickness and comprises a surface called the effective surface, pierced with openings, the said openings being realised by chemical etching and generally arranged in vertical columns; the effective surface is surrounded by a peripheral non-pierced border; a peripheral flange, generally realised by stamping, borders the assembly by extending in a direction noticeably perpendicular to the effective surface. The mask is integrated with the frame by spot welding at the level of the peripheral flange.

The generally rectangular frame has a pair of long sides and a pair of short sides, with a cross-section that is generally L-shaped. The frame must have excellent rigidity, allowing the entire frame/mask to be able, without any modification of shape, to undergo the many manipulations that occur during the manufacturing stages of a cathode ray tube, as explained in the patent U.S. Pat. No. 4,639,230.

To obtain this level of rigidity, the frames of the prior art have a thick cross-section and large weight, which has two disadvantages:
the final weight of the tube, made large by the weight of the frame, which generally reaches three times the weight of the mask.
the final cost of the tube owing to the large cost of the material of the frame

Moreover, it has been observed that a mask formed by stamping is extremely sensitive to heating, caused by the fact that the mask intercepts approximately 70% of the electrons emitted by the gun. The cause of this sensitivity lies in the significant difference in mass between the frame and the mask, meaning that the thermal behaviour of two parts are very different for the assemblies according to the prior art.

Among other advantages, the frame according to the invention reduces the weight of the materials used to manufacture the frame/mask assembly, while improving the thermal behaviour of the said assembly.

To do this, the tube according to the invention comprises:
a front face on which a luminophore screen is arranged on its internal part,
a rear part in the form of a funnel terminating in a cylindrical part in which an electron gun extends in the direction of the longitudinal axis of the tube, axis passing through the centre of the front face,
a colour selection mask formed by stamping and presenting a peripheral flange folded in a direction noticeably parallel to the longitudinal axis
a frame designed to hold the mask at a distance from the screen, the said frame of a noticeably rectangular form has at least one pair of parallel side of a noticeably L-shaped cross-section with a lateral flank extending in a direction parallel to the longitudinal axis connected to a flange noticeably perpendicular to the said longitudinal axis

the said frame being characterized in that the said L-shaped cross-section sides are the short sides of the frame and in that the width of the flange of each short side is smaller in the middle of the side than at its extremities so that the inner edge of the flange defines a curve whose concavity is oriented towards the longitudinal axis of the tube.

The invention and its different advantages will be better understood from the following description and drawings, wherein:

FIG. 1 is a cross-section of a colour cathode ray tube according to the prior art

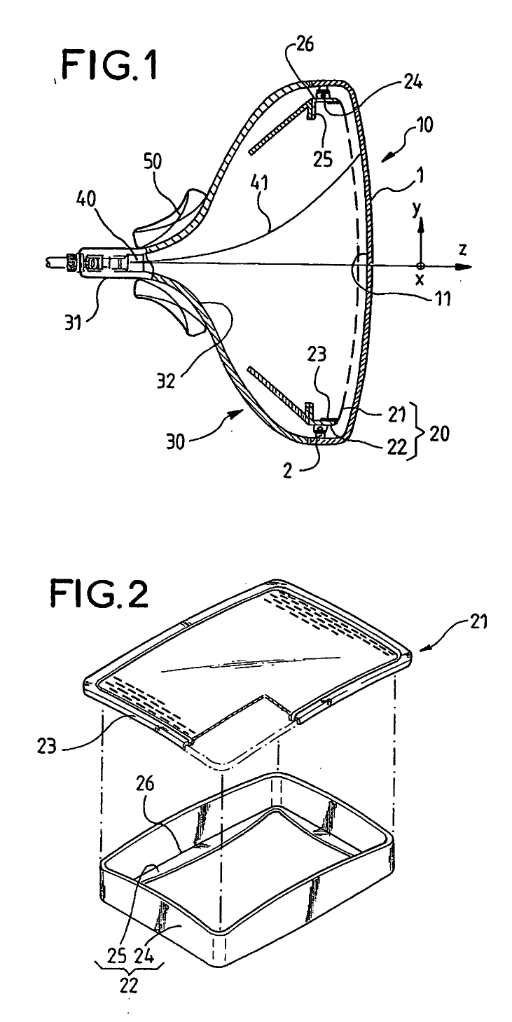

FIG. 2 is a partially exploded perspective view of a frame/mask assembly for cathode ray tubes according to the prior art

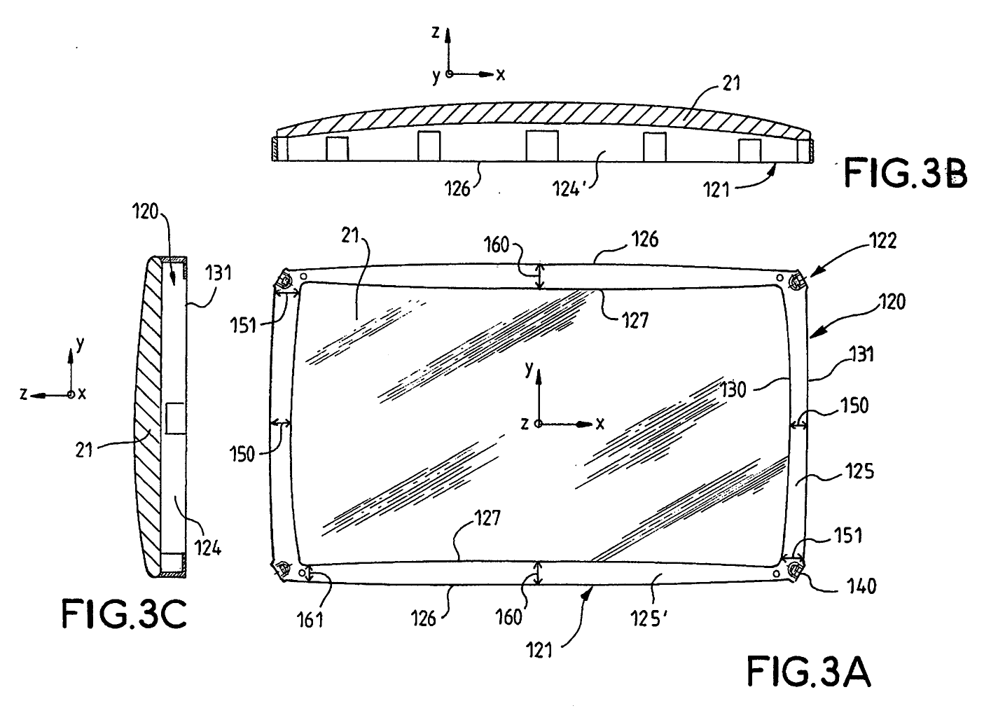

FIGS. 3A, 3B, 3C show the front and side views of a frame/mask assembly according to the invention

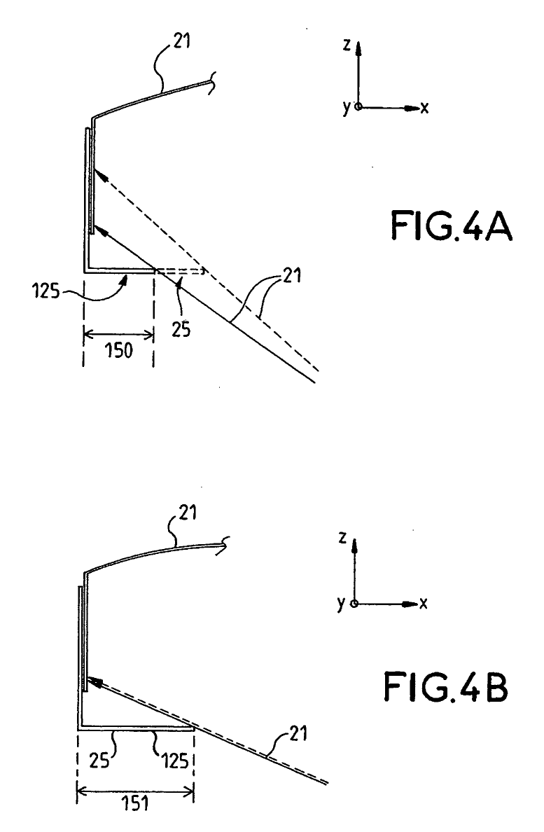

The FIGS. 4A and 4B compare the prior art and the invention in cross-sections of the frame/mask assembly

FIG. 1 shows the structure of a colour cathode ray tube by means of a cross-section. Such a tube 10 contains a frame/mask assembly 20 comprising a shadow mask 21 of which the curved surface is realised by stamping a sheet of steel or invar, a surface that is arranged at a specific distance from a luminophore screen 11 arranged on the glass front face 1 of the tube; the mask is held in place by a rigid frame 22 to which it is joined by welding at the level of its peripheral flange 23 which is folded so as to extend within the frame in a direction noticeably parallel to the longitudinal axis Z. The frame itself is rectangular in shape with the sides at least partly in an L-shaped cross-section, with a flank 24 extending in a direction parallel to the longitudinal axis and a flange 25 noticeably perpendicular to this flank; the flange 25 and the flank 24 are connected to each other at the level of the inner edge 26 of the flank the furthest from the screen.

The tube comprises a rear part in the form of a funnel 30 terminating in a cylindrical collar 31 within which there is an electron gun 40 generating three electronic beams 41 in the direction of the colour selection mask 21. The electronic beams sweep the surface of the screen 11 under the influence of the magnetic deflection device 50.

FIG. 2 illustrates an example of a frame/mask assembly according to the prior art, as described for example in the patent U.S. Pat. No. 6,064,146. The solid frame has a connecting edge 26 and a flange 25 presenting a smaller width at the corners of the frame so as to reduce the weight of the said frame without modifying its rigidity. However, this type of structure has an important difference between the masses of the frame and the mask of which the ratio is generally greater than or equal to three.

When the tube operates, approximately 20 to 30% of the electrons emitted by the gun 40 can pass through the mask by the openings arranged on the surface facing the screen. A large quantity of the electrons are therefore intercepted by the colour selection mask 21 and also collide with the support frame 22. The result is that the frame and the mask undergo thermal dilation, and when the frame and the mask are realised in the same material, for example steel, the dilation of the mask will be more rapid than that of the frame owing to the large difference between the masses of the two elements. The mask, maintained on its periphery by the frame, will then become warped (phenomenon known as “doming”) and the distance from its surface to the luminophore screen will change until the assembly reaches a thermal equilibrium. The modifications of the mask 21/screen 11 distance cause discolorations of the picture on the said screen, the electronic beams no longer correctly illuminating their corresponding luminophores.

It has revealed that two factors affect the appearance of this phenomenon:
the mass ratio between the frame and the screen, which must be less than 2 so as to reduce the time required for the frame/mask assembly to reach its thermal equilibrium, a time that is normally in the order of one and a half hours
the temperature gradient on the surface of the mask, temperature gradient that means that the temperature at the centre of the screen is maximum and minimum at the edges in the prior art. The smaller the temperature gradient, the less apparent are the “doming” phenomena.

The temperature at the periphery of the mask is governed by conditions at the limits: contacts with the frame, thermal inertia of the frame, shape of the edges of the frame enabling the electronic beams to strike the folded peripheral flange 23 of the mask.

FIGS. 3A, 3B, 3C show an embodiment of a frame/mask assembly according to the invention under different views.

FIG. 3A shows a frame 122 according to the invention in a view from behind. The noticeably rectangular-shaped frame comprises two long sides 121 and two short sides 120. The sides of the frame have an L-shaped cross-section with flanges noticeably perpendicular to the longitudinal axis Z, respectively 125 for the short sides and 125′ for the long sides. The flanges are delimited by inner edges, 130 for the short sides, 127 for the long sides, and by outer edges, 131 for the short sides and 126 for the long sides. The sides of the frame also have a flank 124 for the short sides and a flank 124′ for the long sides, a noticeably flat flank parallel to the longitudinal axis Z.

The short sides have a flange whose width varies from the centre to the ends such that the width 150 of the said flange in its middle is less than the width 151 at its extremities. In this manner, the inner edges 130 show concavity oriented inwards so as to allow the electronic beams to intercept a larger part of the surface of the peripheral flange of the mask which is welded to the frame. FIGS. 4A and 4B show a transversal cross-section respectively near the middle of a short side and at its extremity, the lower limits of the flange that the electronic beams can reach for a frame according to the prior art (dotted line) and according to the invention (solid line).

The electronic beams reach the middle of the short sides at higher angles of incidence in the middle of the sides of the frame than at their extremities. Hence, when the flange has a constant width (dotted line), the peripheral flange of the mask is less covered by the electronic beams in the middle than at its extremities, whereas if the width of its extremities reduces towards its centre (solid line) the electronic beams can reach a noticeably constant width of the peripheral flange along the entire length of the part of this flange welded on the short side of the frame. The result is that the mask heats up more evenly with a low temperature gradient between the different parts of the mask. The inner edge 130 of the flange thus has a concavity oriented inwards, with an average radius of curvature lower than the average radius of curvature of its outer edge 131. In an embodiment according to the invention designed for a tube with a screen diagonal in the order of 60 cm, illustrated by the FIGS. 3A, 3B, 3C the 16/9 format frame has an inner edge 130 with an average radius of curvature of about 1.1 metres and an outer edge 131 with a radius of curvature in the order of 2.2 metres.

The arched form of the flange gives the frame a great mechanical rigidity allowing a reduction in the quantity of metal used to produce the said frame. The rigidity of the frame/mask assembly can be improved by coupling the arched form of the flanges of the short sides with the flanges of the long sides presenting on the contrary a width 160 at its middle that is greater than its width 161 at its extremities. In the embodiment according to FIGS. 3A, 3B, 3C the inner edge 127 of the flange has a concavity oriented outwards from the frame and outer edge 126 has a concavity oriented inwards. The radii of curvature of the outer and inner edges are respectively in the order of 7 m and 7.3 m.

Although the type of frame structure according to the invention can be adapted to all types of suspension means in the tube of the frame/mask assembly, the rigidity of the said assembly, once inserted in the tube is improved by suspension means arranged at the corners. Hence, suspension springs can be arranged in the corners 140 of the frame to co-operate with the lugs inserted in the glass peripheral flange of the front part 1 of the tube. In this manner, it is possible both to reduce the quantity of material used to produce the frame and to use a steel frame/mask assembly, a less expensive material than invar.

In the embodiment according to FIGS. 3A to 3C, it is noted that the thermal behaviour of the frame/mask assembly improves as soon as the ratio between the weight of the mask and the weight of the frame is greater than 0.5 and tends preferentially to 1. Hence, for a tube with a screen diagonal of 60 cm in 16/9 form, the mask chosen is made of steel with a 0.25 mm thickness, whereas the frame, in the same material has a thickness of 0.5 mm; the result is a mask weighing approximately 340 g and a frame of approximately 450 g, which gives a mass ratio of approximately 0.75.

1/ Cathode ray tube comprising:
a front face on which a luminophore screen is arranged on its internal part,
a rear part in the form of a funnel terminating in a cylindrical part in which an electron gun extends in the direction of the longitudinal axis Z of the tube, axis passing through the centre of the front face,
a colour selection mask formed by stamping and presenting a peripheral flange folded in a direction noticeably parallel to the longitudinal axis
a frame designed to hold the mask at a distance from the screen, the said frame of a noticeably rectangular form has at least one pair of parallel sides of a noticeably L-shaped cross-section with a lateral flank extending in a direction parallel to the longitudinal axis connected to a flange noticeably perpendicular to the said longitudinal axis
wherein the said L-shaped cross-section sides are the short sides of the frame and in that the width of the flange of each short side is smaller in the middle of the side than at its extremities so that the inner edge of the flange defines a curve whose concavity is oriented toward the longitudinal axis of the tube

2/ Cathode ray tube according to claim 1 wherein the long sides of the frame comprise an L-shaped cross-section and in that the width of the flange of each long side is greater in the middle of the said side than at its extremities

3/ Cathode ray tube according to claim 2 wherein the inner edge the said flange defines a curve whose concavity is oriented outwards from the frame.

4/ Cathode ray tube according to the claim 1 wherein the mask is made of steel.

5/ Cathode ray tube according to claim 2 wherein the weight of the frame is less than two times the weight of the mask.

6/ Cathode ray tube according to claim 1 wherein the connecting edge of the flange to the lateral flank defines a curve whose concavity is oriented toward the longitudinal axis of the tube

7/ Cathode ray tube according to claim 1 wherein the frame/mask assembly is held inside the tube by a support means at the corners of the frame.
